(19) United States
(12) Patent Application Publication
(10) Pub. No.: US 2012/0054402 A1
(43) Pub. Date: Mar. 1, 2012

(54) COMMUNICATIVELY COUPLING, AT LEAST IN PART, SERIAL BUS CONTROLLER TO AT LEAST ONE SERIAL BUS DEVICE

(76) Inventors: Dhinesh Sasidaran, Seremban (MY); Asad Azam, Limerick (IE); Zeeshan Sarwar, Lahore (PK)

(21) Appl. No.: 12/870,145

(22) Filed: Aug. 27, 2010

(51) Int. Cl. G06F 13/40

(52) U.S. Cl. 710/305

(57) ABSTRACT

An embodiment may include circuitry to communicatively couple, at least in part, a serial bus controller to at least one serial bus device. The circuitry may have at least one port to be communicatively coupled to the at least one device. The circuitry may route, at least in part, at least one packet issued, at least in part, from the controller to the at least one device via the at least one port based at least in part upon at least one address. The circuitry may associate, at least in part, the at least one address with the at least one port. The at least one address may be assigned, at least in part, to the at least one device by the controller as a result, at least in part, of enumeration, at least in part, of the at least one device by the controller.

### FIELD

This disclosure relates to communicatively coupling, at least in part, a serial bus controller to at least one serial bus device.

### BACKGROUND

In one conventional arrangement, a Universal Serial Bus (USB) controller is coupled to a plurality of USB devices via a shared USB bus. In accordance with USB architecture, when the controller transmits information intended for one of the devices, the information is broadcast via the bus to all of the devices coupled to the bus. The power consumed in such a bus transaction is directly related to the number devices coupled to the bus. Thus, as the number of devices coupled to the bus increases, the amount of power consumed in each such transmission from the controller also increases. Additionally, the broadcasting of information intended for a given recipient to all of the devices coupled to the bus may raise information privacy and/or security concerns.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates features in an embodiment.

FIG. 2 illustrates features in an embodiment.

FIG. 3 illustrates operations in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

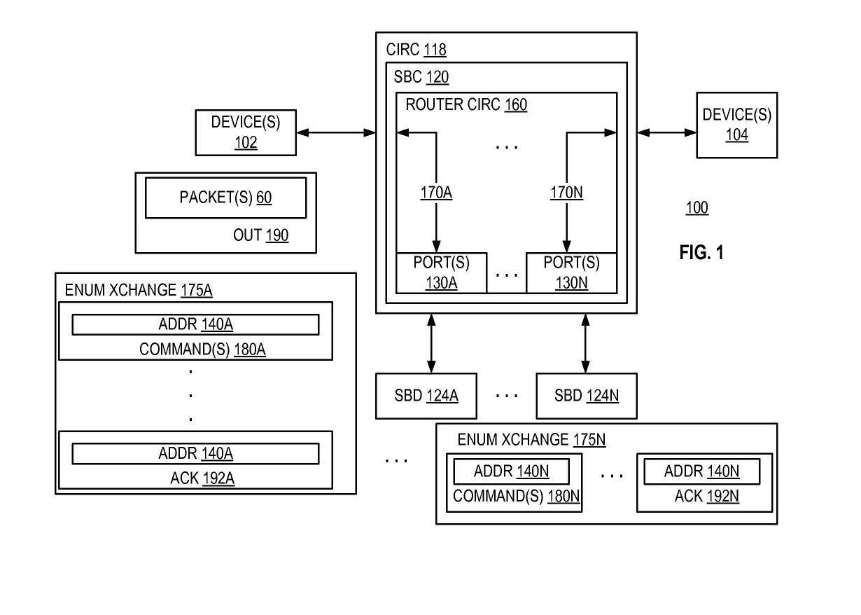

FIG. 1 illustrates a system embodiment 100. System 100 may include circuitry 118 that may be communicatively coupled, at least in part, to one or more devices 102 and/or one or more devices 104. In this embodiment, circuitry 118 may comprise serial bus controller (SBC) 120) that may comprise router circuitry 160. Router circuitry 160 may comprise one or more (and in this embodiment, a plurality of) ports 130A . . . 130N. Ports 130A . . . 130N may be capable of being communicatively coupled, at least in part, to serial bus devices (SBD) 124A . . . 124N. For example, in this embodiment, one or more ports 130A may be communicatively coupled to one or more SBD 124A, and one or more ports 130N may be communicatively coupled to one or more SBD 124N.

In this embodiment, a first entity may be “communicatively coupled” to a second entity if the first entity is capable of, at least in part, transmitting to and/or receiving from the second entity one or more commands and/or data, such as, for example, via one or more wired and/or wireless communication links. In this embodiment, a “wireless communication link” may mean any modality, and/or portion thereof, that permits, at least in part, at least two entities to be wirelessly communicatively coupled, at least in part. In this embodiment, a “wired communication link” may mean any modality and/or portion thereof, that permits, at least in part, at least two entities to be communicatively coupled, at least in part, via non-wireless means, at least in part. Also as used in this embodiment, data may be or comprise one or more commands, and/or one or more commands may be or comprise data. Additionally, in this embodiment, “circuitry” may comprise singly or in any combination, analog circuitry, digital circuitry, hardwired circuitry, programmable circuitry, state machine circuitry, and/or memory that may comprise program instructions that may be executed by programmable circuitry.

In this embodiment, a serial bus may comprise one or more wired and/or wireless communication links via which data may be serially and/or sequentially transmitted, at least in part. Additionally, in this embodiment, a device may comprise circuitry capable of performing, at least in part, one or more functions and/or operations. Also in this embodiment, a serial bus device and/or a serial bus controller each may comprise circuitry capable of being communicatively coupled, at least in part, directly and/or indirectly, to one or more serial buses.

Additionally, in this embodiment, a processor, host processor, central processing unit, and/or a controller may be used interchangeably, and may comprise circuitry capable of performing, at least in part, one or more arithmetic and/or logical operations. Also, in this embodiment, a port may comprise circuitry capable of communicatively coupling, at least in part, at least two entities. In this embodiment, the enumeration of a first device by a second device may comprise transmission, at least in part, and/or reception, at least in part, of one or more signals, commands and/or data that may result, at least in part, in and/or from the second device (1) determining, at least in part, the presence of the first device and/or one or more characteristics, parameters, capabilities, functions, and/or operations of the first device, and/or (2) assigning to, at least in part, and/or to associating with, at least in part, the first device one or more characteristics, parameters, capabilities, functions, and/or operations. Also, in this embodiment, a packet may comprise one or more symbols and/or values. In this embodiment, routing may comprise, involve, facilitate, permit, and/or implement transmission of one or more packets from one or more senders of the one or more packets to one or more recipients thereof.

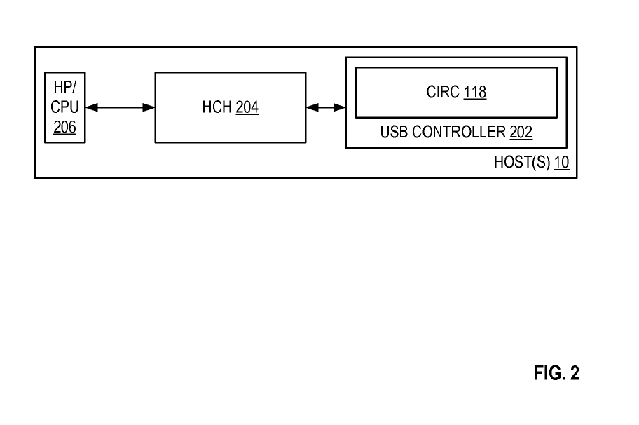

Although not shown in the Figures, circuitry 118 may comprise computer-readable/writable memory. Such memory may comprise, for example, one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable memory. Machine-readable program instructions may be stored in such memory and may be executed by circuitry 118, controller 120, and/or router circuitry 160. When so executed, this may result in circuitry 118, controller 120, circuitry 160, and/or other components in system 100 and/or host 10 (see FIG. 2) performing the operations described herein as being performed by these components.

In this embodiment, circuitry 118, controller 120, circuitry 160, ports 130A . . . 130N, and/or devices 124A . . . 124N may be compatible with the Universal Serial Bus Specification Revision 2.0, published Apr. 27, 2000, copyright 2000, Compaq Computer Corporation, et al. and/or Universal Serial Bus 3.0 Specification, Revision 1.0, published Nov. 12, 2008, Hewlett-Packard Company et al. (hereinafter collectively and/or singly referred to as “USB protocol”). Thus, for example, ports 130A . . . 130N may be or comprise USB protocol compatible interfaces that may be electrically and physically mated with devices 124A . . . 124N. When so electrically and physically mated, devices 124A . . . 124N (and/or other components thereof) may be capable of exchanging data and/or one or more commands with circuitry 118, controller 120, and/or circuitry 160 in accordance with the USB protocol. Thus, in this embodiment, circuitry 118, SBC 120, circuitry 160, and/or devices 124A . . . 124N may be or comprise USB protocol compatible devices.

As shown in FIG. 2, one or more hosts 10 may comprise USB compatible controller 202 that may be communicatively coupled via to one or more host controller hubs (HCH) 204 to one or more host processors (HP)/central processing units (CPU) 206. USB controller 202 may comprise, at least in part, circuitry 118. In this embodiment, HCH 204 may be, comprise, and/or be comprised in, at least in part, one or more chipsets. In this embodiment, a “chipset” may comprise circuitry capable of communicatively coupling, at least in part, one or more processors, memory, and/or other circuitry, such as, for example, one or more memory controller hubs, platform controller hubs, and/or input/output controller hubs. In this embodiment, controller 202, HCH 204, and/or HP/CPU 206 may be one or more respective not integrated circuit chips, die, and/or substrates that may be physically distinct from each other, at least in part. However, alternatively, although not shown in the Figures, some or all of the components of controller 202 and/or circuitry 118 may be comprised in HCH 204. Also alternatively, some or all of the components of HCH 204 may be comprised in HP/CPU 206.

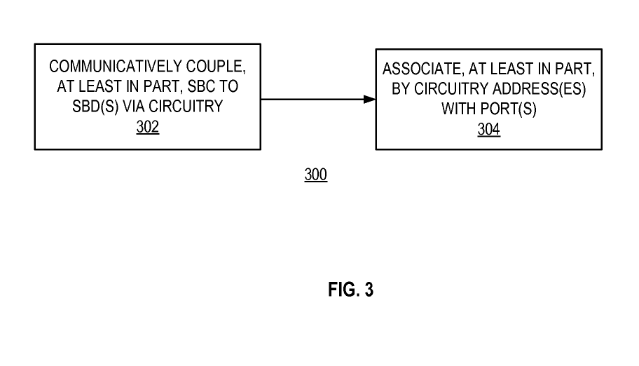

With reference being made to FIG. 3, system 100 may perform, at least in part, operations 300. For example, in operation of system 100, after a reset of system 100, circuitry 118, controller 120, and/or circuitry 160, one or more (and in this embodiment, the plurality) of devices 124A . . . 124N may be physically and electrically mated with one or more (and in this embodiment, the plurality) of ports 130A . . . 130N. This may result in the one or more (and in this embodiment, the plurality) of the ports 130A . . . 130N being communicatively coupled, at least in part, to the one or more (and in this embodiment, the plurality) of the devices 124A . . . 124N. As a result, controller 120 may be communicatively coupled, at least in part, to the one or more (and in this embodiment, the plurality) of the devices 124A . . . 124N via the one or more (and in this embodiment, the plurality) of the ports 130A . . . 130N, circuitry 160, and/or circuitry 118 (see operation 302). For example, as a result, at least in part, of operation 302, one or more devices 124A may be communicatively coupled, at least in part, via one or more ports 130A to circuitry 160, controller 120, and/or circuitry 118. Also, for example, as a result, at least in part, of operation 302, one or more devices 124N may be communicatively coupled, at least in part, via one or more ports 130N to circuitry 160, controller 120, and/or circuitry 118.

Thereafter, and/or contemporaneously therewith at least in part, controller 120 may commence, at least in part, enumerations of one or more of the devices 124A . . . 124N. As part of the operations involved in the enumeration, enumeration exchanges 175A . . . 175N may be carried out between controller 120 and each of the devices 124A . . . 124N. For example, as part of the enumeration of one or more devices 124A by controller 120, enumeration exchange 175A may occur between controller 120 and one or more devices 124A. Also for example, as part of the enumeration of one or more devices 124N by controller 120, enumeration exchange 175N may occur between controller 120 and one or more devices 124N.

As part of exchange 175A, controller 120 may issue to one or more devices 124A one or USB protocol SET_ADDRESS commands 180A via one or more ports 130A. One or more USB SET_ADDRESS commands 180A may be issued by the controller 120, after, for example, coupling of one or more devices 124A to one or more ports 130A and/or a USB protocol reset. One or more commands 180A may comprise one or more addresses 140A assigned, at least in part, to one or more devices 124A by controller 120, one or more devices 102, and/or one or more devices 104. For example, with reference to FIG. 2, one or more devices 102 and/or one or more devices 104 may be or comprise, one or more HP/CPU 206, HCH 204, one or more not shown user interface devices, and/or one or more components thereof. The issuance of these one or more commands 180A may result from the assignment, at least in part, of one or more addresses 140A to one or more devices 124A, and/or may result in one or more devices 124A assigning the one or more addresses 140A to one or more devices 124A. In this embodiment, an address may comprise, encode, specify, and/or indicate, at least in part, one or more symbols and/or values comprise, encode, specify, and/or indicate, at least in part, one or more physical, logical, and/or virtual locations. Router circuitry 160 may store a local copy of one or more addresses 140A from one or more commands 180A for later use.

In response at least in part to the one or more commands 180A, the one or more devices 124A may issue to controller 120, via one or more ports 130A, one or more USB protocol acknowledgements (ACK) 192A, at least in part, of the one or more commands 180A and/or the one or more addresses 140A assigned, at least in part, to the one or more devices 124A. One or more acknowledgements 192A may comprise, indicate, and/or specify, at least in part, one or more addresses 140A. Router circuitry 160 may associate (e.g., in one or more not shown tables in memory) the one or more addresses 140A that are assigned to one or more devices 124A with (1) the one or more ports 130A via which one or more acknowledgements 192A are received by router circuitry 160, and/or (2) the one or more devices 124A that may be communicatively coupled to the one or more ports 130A. Thus, in this embodiment, circuitry 160 may associate, at least in part, one or more addresses 140A with one or more devices 124A and/or one or more ports 130A based at least in part upon the one or more commands 180A, one or more acknowledgements 192A, and/or the one or more ports 130A via which circuitry 160 may receive the one or more acknowledgements 192A from one or more devices 124A (see operation 304).

As part of exchange 175N, controller 120 may issue to one or more devices 124N one or USB protocol SET_ADDRESS commands 180N via one or more ports 130N. One or more USB SET_ADDRESS commands 180N may be issued by the controller 120, after, for example, coupling of one or more devices 124N to one or more ports 130N and/or a USB protocol reset. One or more commands 180N may comprise one or more addresses 140N assigned, at least in part, to one or more devices 124N by controller 120, one or more devices 102, and/or one or more devices 104. The issuance of these one or more commands 180N may result from the assignment, at least in part, of one or more addresses 140N to one or more devices 124N, and/or may result in one or more devices 124N assigning the one or more addresses 140N to one or more devices 124N. Router circuitry 160 may store a local copy of one or more addresses 140N from one or more commands 180N for later use.

In response at least in part to the one or more commands 180N, the one or more devices 124N may issue to controller 120, via one or more ports 130N, one or more USB protocol acknowledgements (ACK) 192N, at least in part, of the one or more commands 180N and/or the one or more addresses 140N assigned, at least in part, to the one or more devices 124N. One or more acknowledgements 192N may comprise, indicate, and/or specify, at least in part, one or more addresses 140N. Router circuitry 160 may associate (e.g., in the one or more not shown tables in memory) the one or more addresses 140N that are assigned to one or more devices 124N with (1) the one or more ports 130N via which one or more acknowledgements 192N are received by router circuitry 160, and/or (2) the one or more devices 124N that may be communicatively coupled to the one or more ports 130N. Thus, in this embodiment, circuitry 160 may associate, at least in part, one or more addresses 140N with one or more devices 124N and/or one or more ports 130N based at least in part upon the one or more commands 180N, one or more acknowledgements 192N, and/or the one or more ports 130N via which circuitry 160 may receive the one or more acknowledgements 192N from one or more devices 124N (see operation 304).

After the respective enumerations of the devices 124A . . . 124N, router circuitry 160 may route, at least in part, one or more packets issued from the controller 120 to one or more of the devices 124A . . . 124N intended to receive the one or more packets, such that the one or more packets may not be received by one or more others of the devices 124A . . . 124N that are not intended to receive the one or more packets. For example, after these respective enumerations, one or more devices 102 may issue, at least in part, one or more packets 60 to circuitry 118 and/or controller 120 that are intended to be received by one or more devices 124A. In response, at least in part, to one or more packets 60, controller 120 issue, at least in part, one or more USB OUT transactions 190 that may comprise, at least in part, one or more packets 60 and may address one or more devices 124A (e.g., may comprise, specify, and/or indicate, at least in part, one or more addresses 140A). This may result, at least in part, in one or more packets 60 being issued, at least in part, by controller 120.

In response to and/or based, at least in part, upon one or more transactions 190, router circuitry 160 may route, at least in part, one or more packets 60 via one or more point-to-point connections 170A to one or more devices 124A via one or more ports 130A, based at least in part upon the one or more addresses 140A comprised, indicated, and/or specified, at least in part, in one or more transactions 190. One or more point-to-point connections 170A may be provided by and/or comprised in, at least in part, router circuitry 160, and may by-pass, at least in part, all of the other ports (e.g., one or more ports 130N) that may be communicatively coupled to any device (e.g., one or more devices 124N) other than one or more devices 124A.

For example, as stated previously, as a result, at least in part, of operation 304, router circuitry 160 may associate, at least in part, one or more addresses 140A with one or more devices 124A and/or one or more ports 130A. Based at least in part upon the one or more addresses 140A comprised, indicated, and/or specified, at least in part, in one or more transactions 190, circuitry 160 may provide one or more point-to-point connections 170A that may route, at least in part, one or more packets 60 to the one or more ports 130A that may be coupled to the one or more devices 124A that may be addressed, at least in part, by one or more addresses 140A. These one or more point-to-point connections 170A may by-pass, at least in part, all of the other ports (e.g., one or more ports 130N) that may be communicatively coupled to any device (e.g., one or more devices 124N) other than one or more devices 124A addressed by one or more addresses 140A.

Also, for example, one or more packets 60 may instead be intended to be received by one or more devices 124N. In this case, in response, at least in part, to one or more packets 60, controller 120 may issue, at least in part, one or more USB OUT transactions 190 that may comprise, at least in part, one or more packets 60 and may address one or more devices 124N (e.g., may comprise, specify, and/or indicate, at least in part, one or more addresses 140N). This may result, at least in part, in one or more packets 60 being issued, at least in part, by controller 120.

In response to and/or based, at least in part, upon one or more transactions 190, router circuitry 160 may route, at least in part, one or more packets 60 via one or more point-to-point connections 170N to one or more devices 124N via one or more ports 130N, based at least in part upon the one or more addresses 140N comprised, indicated, and/or specified, at least in part, in one or more transactions 190. One or more point-to-point connections 170N may be provided by and/or comprised in, at least in part, router circuitry 160, and may by-pass, at least in part, all of the other ports (e.g., one or more ports 130A) that may be communicatively coupled to any device (e.g., one or more devices 124A) other than one or more devices 124N.

For example, as stated previously, as a result, at least in part, of operation 304, router circuitry 160 may associate, at least in part, one or more addresses 140N with one or more devices 124N and/or one or more ports 130N. Based at least in part upon the one or more addresses 140N comprised, indicated, and/or specified, at least in part, in one or more transactions 190, circuitry 160 may provide one or more point-to-point connections 170N that may route, at least in part, one or more packets 60 to the one or more ports 130N that may be coupled to the one or more devices 124N that may be addressed, at least in part, by one or more addresses 140N. These one or more point-to-point connections 170N may by-pass, at least in part, all of the other ports (e.g., one or more ports 130A) that may be communicatively coupled to any device (e.g., one or more devices 124A) other than one or more devices 124N addressed by one or more address 140N.

In this embodiment, router circuitry 160 may differentiate between enumeration traffic (e.g., comprised in exchanges 175A . . . 175N), and one or more transactions 190, based at least in part upon whether such traffic addresses a default address or a non-default address. For example, although enumeration traffic may comprise and/or specify one or more addresses (e.g., one or more addresses 140A) to be assigned to one or more devices, the traffic itself may be addressed to a default value to be used following USB protocol and/or connection reset (e.g., address 0). However, transactions 190 may use addresses that may not be set to this default value.

Additionally, in this embodiment, if USB protocol is employed, in compliance with such protocol, communication via the ports 130A . . . 130N with SBD 124A . . . 124N may be enabled on a port-by-port/SBD-by-SBD basis. For example, in accordance with such protocol, after coupling of the respective SBD 124A . . . 124N to the respective ports 130A . . . 130N, but prior to transmission of respective SET_ADDRESS commands to the respective SBD, each respective SBD may be initially assigned a default address of 0 (zero). SBC 120 may enable each respective port 130A . . . 130N in a predefined sequence order (e.g., corresponding to respective port numbers assigned to the respective ports) by (1) detecting the respective communication speed of the respective SBD coupled to the respective port, (2) issuing to the respective port a respective USB protocol reset, and (3) issuing a respective SET_ADDRESS command, in accordance with this sequence order. After a given port has been enabled by carrying out these three operations, SBC 120 may proceed to enable the next port in the sequence order, until the last port in the sequence order has been enabled In accordance with USB protocol, unless and until a given port has been enabled, traffic may not be routed to that port. Also in accordance with USB protocol, the foregoing enabling operations may be carried out by the controller 120, in the predefined sequence order, on a single SBD-by-single SBD basis (i.e., not on a one-to-many or many-to-one basis).

Thus, an embodiment may include circuitry to communicatively couple, at least in part, a serial bus controller to at least one serial bus device. The circuitry may have at least one port to be communicatively coupled to the at least one device. The circuitry may route, at least in part, at least one packet issued, at least in part, from the controller to the at least one device via the at least one port based at least in part upon at least one address. The circuitry may associate, at least in part, the at least one address with the at least one port. The at least one address may be assigned, at least in part, to the at least one device by the controller as a result, at least in part, of enumeration, at least in part, of the at least one device by the controller.

Thus, in this embodiment, when the controller 120 transmits one or more packets 60 as a result, at least in part, of one or more transactions 190, router circuitry 160 may not broadcast one or more packets 60 to all of the devices 124A . . . 124N, but instead may transmit the one or more packets 60 only to the one or more devices (e.g., one or more devices 124A) that are specifically intended by the sender to receive the one or more packets 60. Advantageously, in this embodiment, this may permit the power consumed in such transactions both to be reduced and to be essentially independent of the number of serial bus devices coupled to the controller. Further advantageously, since, in this embodiment, point-to-point communications may be used (instead of broadcast communications) for such transactions, information privacy and/or security may be improved.

Many alternatives, modifications, and variations are possible without departing from this embodiment. For example, although not shown in the Figures, SBD 124A . . . 124N may comprise one or more hubs (e.g., USB protocol hubs) that may be communicatively coupled to multiple USB protocol end devices. In this arrangement, after the SBC 120 has been communicatively coupled, at least in part, to such a USB hub (see operation 302), circuitry 118 and/or circuitry 160 may associate, at least in part, multiple addresses (e.g., for the end devices coupled to the hub) with a respective port (e.g., port 130A) in circuitry 160) to which the USB hub may be coupled.

Many other and/or additional alternatives, modifications, and variations are possible without departing from this embodiment. Accordingly, the claims are intended to cover all such alternatives, modifications, and variations.

What is claimed is:

1. An apparatus comprising:
circuitry to communicatively couple, at least in part, a serial bus controller to at least one serial bus device, the circuitry having at least one port to be communicatively coupled to the at least one serial bus device, the circuitry to route, at least in part, at least one packet issued, at least in part, from the serial bus controller to the at least one serial bus device via the at least one port based at least in part upon at least one address, the circuitry being to associate, at least in part, the at least one address with the at least one port, the at least one address being assigned, at least in part, to the at least one device by the controller as a result, at least in part, of enumeration, at least in part, of the at least one device by the controller.

2. The apparatus of claim 1, wherein:
the at least one port comprises a first port and a second port;
the at least one device comprises a first serial bus device and a second serial bus device;
the first port is to be coupled to the first device;
the second port is to be coupled to the second device;
the circuitry is to associate, at least in part, the at least one address with the first port;
the circuitry is to associate, at least in part, at least one other address with the second port, the at least one other address being assigned, at least in part, to the second device by the controller as a result, at least in part, of another enumeration, the another enumeration being, at least in part, of the second device by the controller; and
the circuitry is to route, at least in part, the at least one packet to the first device via at least one point-to-point connection that by-passes, at least in part, the second port.

3. The apparatus of claim 1, wherein:
the enumeration comprises, at least in part, issuance, at least in part, by the controller to the at least one device of a Universal Serial Bus (USB) SET_ADDRESS command; and
the circuitry is to associate, at least in part, the at least one address with the at least one port based at least in part upon the command.

4. The apparatus of claim 3, wherein:
the at least one packet is issued, at least in part, by the controller as a result, at least in part, of a USB OUT transaction involving, at least in part, the at least one address;
the circuitry is to be coupled to another serial device that is to be enumerated, at least in part, by the controller; and
the circuitry is to route, at least in part, the at least one packet to the at least one device via at least one point-to-point connection that by-passes, at least in part, the another serial device.

5. The apparatus of claim 1, wherein:
the enumeration comprises, at least in part, acknowledgement, at least in part, by the at least one device of assignment, at least in part, by the controller of the at least one address, the acknowledgement to be issued, at least in part, from the at least one device to the controller via the at least one port; and
the circuitry is to associate, at least in part, the at least one address with the at least one port based at least in part upon the acknowledgement.

6. The apparatus of claim 1, wherein:
a Universal Serial Bus (USB) controller comprises, at least in part, the circuitry; and
the USB controller is to be communicatively coupled to a host controller hub; and
the host controller hub is to be communicatively coupled to a host central processing unit.

7. A method comprising:
communicatively coupling, at least in part, via circuitry, a serial bus controller to at least one serial bus device, the circuitry having at least one port to be communicatively coupled to the at least one serial bus device, the circuitry to route, at least in part, at least one packet issued, at least in part, from the serial bus controller to the at least one serial bus device via the at least one port based at least in part upon at least one address; and
associating, at least in part, by the circuitry the at least one address with the at least one port, the at least one address being assigned, at least in part, to the at least one device by the controller as a result, at least in part, of enumeration, at least in part, of the at least one device by the controller.

8. The method of claim 7, wherein:
the at least one port comprises a first port and a second port;
the at least one device comprises a first serial bus device and a second serial bus device;
the first port is to be coupled to the first device;
the second port is to be coupled to the second device;
the circuitry is to associate, at least in part, the at least one address with the first port;
the circuitry is to associate, at least in part, at least one other address with the second port, the at least one other address being assigned, at least in part, to the second device by the controller as a result, at least in part, of another enumeration, the another enumeration being, at least in part, of the second device by the controller; and
the circuitry is to route, at least in part, the at least one packet to the first device via at least one point-to-point connection that by-passes, at least in part, the second port.

9. The method of claim 7, wherein:
the enumeration comprises, at least in part, issuance, at least in part, by the controller to the at least one device of a Universal Serial Bus (USB) SET_ADDRESS command; and
the circuitry is to associate, at least in part, the at least one address with the at least one port based at least in part upon the command.

10. The method of claim 9, wherein:
the at least one packet is issued, at least in part, by the controller as a result, at least in part, of a USB OUT transaction involving, at least in part, the at least one address;
the circuitry is to be coupled to another serial device that is to be enumerated, at least in part, by the controller; and
the circuitry is to route, at least in part, the at least one packet to the at least one device via at least one point-to-point connection that by-passes, at least in part, the another serial device.

11. The method of claim 7, wherein:
the enumeration comprises, at least in part, acknowledgement, at least in part, by the at least one device of assignment, at least in part, by the controller of the at least one address, the acknowledgement to be issued, at least in part, from the at least one device to the controller via the at least one port; and
the circuitry is to associate, at least in part, the at least one address with the at least one port based at least in part upon the acknowledgement.

12. The method of claim 7, wherein:
a Universal Serial Bus (USB) controller comprises, at least in part, the circuitry; and
the USB controller is to be communicatively coupled to a host controller hub; and
the host controller hub is to be communicatively coupled to a host central processing unit.

13. Computer-readable memory storing one or more instructions that when executed by a machine result in execution of operations comprising:
communicatively coupling, at least in part, via circuitry, a serial bus controller to at least one serial bus device, the circuitry having at least one port to be communicatively coupled to the at least one serial bus device, the circuitry to route, at least in part, at least one packet issued, at least in part, from the serial bus controller to the at least one serial bus device via the at least one port based at least in part upon at least one address; and
associating, at least in part, by the circuitry the at least one address with the at least one port, the at least one address being assigned, at least in part, to the at least one device by the controller as a result, at least in part, of enumeration, at least in part, of the at least one device by the controller.

14. The memory of claim 13, wherein:
the at least one port comprises a first port and a second port;
the at least one device comprises a first serial bus device and a second serial bus device;
the first port is to be coupled to the first device;
the second port is to be coupled to the second device;
the circuitry is to associate, at least in part, the at least one address with the first port;
the circuitry is to associate, at least in part, at least one other address with the second port, the at least one other address being assigned, at least in part, to the second device by the controller as a result, at least in part, of another enumeration, the another enumeration being, at least in part, of the second device by the controller; and
the circuitry is to route, at least in part, the at least one packet to the first device via at least one point-to-point connection that by-passes, at least in part, the second port.

15. The memory of claim 13, wherein:
the enumeration comprises, at least in part, issuance, at least in part, by the controller to the at least one device of a Universal Serial Bus (USB) SET_ADDRESS command; and
the circuitry is to associate, at least in part, the at least one address with the at least one port based at least in part upon the command.

16. The memory of claim 15, wherein:
the at least one packet is issued, at least in part, by the controller as a result, at least in part, of a USB OUT transaction involving, at least in part, the at least one address;
the circuitry is to be coupled to another serial device that is to be enumerated, at least in part, by the controller; and
the circuitry is to route, at least in part, the at least one packet to the at least one device via at least one point-to-point connection that by-passes, at least in part, the another serial device.

17. The memory of claim 13, wherein:
the enumeration comprises, at least in part, acknowledgement, at least in part, by the at least one device of assignment, at least in part, by the controller of the at least one address, the acknowledgement to be issued, at least in part, from the at least one device to the controller via the at least one port; and
the circuitry is to associate, at least in part, the at least one address with the at least one port based at least in part upon the acknowledgement.

18. The memory of claim 13, wherein:
a Universal Serial Bus (USB) controller comprises, at least in part, the circuitry; and
the USB controller is to be communicatively coupled to a host controller hub; and
the host controller hub is to be communicatively coupled to a host central processing unit.
